(19) United States
(12) Patent Application Publication
(10) Pub. No.: US 2026/0161548 A1
(43) Pub. Date: Jun. 11, 2026

(54) HARDWARE ACCELERATION FOR DATA PROCESSING ON MEMORY DEVICES

(71) Applicant: SK Hynix NAND Product Solutions Corp. (dba Solidigm), Rancho Cordova, CA (US)

(72) Inventors: Lukasz PORYCKI, Nowy Dwor Gdanski (PL); Mariusz BARCZAK, Gdansk (PL); Samuel BRADSHAW, Sacramento, CA (US)

(21) Appl. No.: 18/977,304

(22) Filed: Dec. 11, 2024

(51) Int. Cl. G06F 12/02

(52) U.S. Cl. CPC G06F 12/0246

(57) ABSTRACT

This application is directed to data processing in a memory device having hardware acceleration capabilities. The memory device has a memory controller, a data processor, and non-volatile memory. The memory device obtains an operating system (OS) image. The memory device executes an OS on the data processor based on the OS image, and the OS includes a block device driver for managing data having a predefined format. The memory device provides, via the block device driver, payload data having the predefined format, and generates input data having a first format associated with a firmware program based on the payload data. The memory device implements the firmware program external to the OS to process the input data.

### TECHNICAL FIELD

This application relates generally to electronic systems including, but not limited to, methods, systems, and non-transitory computer-readable media for implementing hardware-based acceleration for in-memory data processing capabilities created in memory devices.

### BACKGROUND

Memory is used to store instructions and data in an electronic system. The data are processed by one or more processors of the electronic system according to the instructions stored in the memory. Multiple memory units are used in different portions of the electronic system to serve distinct functions. Specifically, the electronic system includes non-volatile memory that acts as secondary memory to keep data stored thereon if the electronic system is decoupled from a power source. Examples of the secondary memory include, but are not limited to, hard disk drives (HDDs) and solid-state drives (SSDs). The secondary memory is connected to and collaborates with an external electronic device (such as a host device) equipped with one or more processors focused on data processing. A memory controller in the secondary memory manages its storage space and handles read, write, and read-modify-write requests from the external device. In addition to storage, the secondary memory is also designed to load an operating system (OS), allowing for limited local in-memory data processing capabilities. Various software applications or drivers are installed on this OS to enable a range of data processing functions. However, the secondary memory often has limited processing resources, which may impose restrictions on installation and performance of some applications or drivers, thereby limiting its in-memory processing abilities. Exploring alternative solutions to enhance in-memory processing capabilities on various memory devices would be beneficial.

### SUMMARY

Various embodiments of this application are directed to methods, systems, devices, non-transitory computer-readable media for utilizing data processing capabilities enabled on a firmware level of a memory device to facilitate operations of a data processor of the memory device. In some embodiments, the memory device is transformed to a computational storage device (CSD) by incorporating at least one computing element (e.g., the data processor). The data processor is configured to process internal computational workloads (e.g., the data processing operations) locally on the memory device, while a memory controller of the memory device specializes in performing memory access functions and internal memory management functions. The memory controller includes a plurality of data processing engines applied formed on a firmware level. These data processing engines may be created for the data processor, and/or they may be natively applied in the memory access functions and internal memory management functions of the memory device. Some implementations of this application are directed to utilizing these data processing engines to process data and provide them to the data processor, allowing the data processor to implement additional data processing operations on the provided data. As such, the data processor of the memory device does not need to install its own software programs or data drivers in an OS loaded on the data processor to repeat the same functions of the firmware-level data processing engines. Stated another way, the data processing engines are implemented on a hardware or firmware level, and may provide hardware acceleration to the data processing operations of the data processor of the memory device without requiring installation of the software programs or data drivers in the OS loaded on the data processor.

In some embodiments, hardware acceleration capabilities of a memory device are enabled by the data processing engines, and used to avoid and/or minimize customization of the guest OS (e.g., an embedded OS) loaded on the data processor of a memory device. Further, in some embodiments, a hypervisor is implemented on a CSD (e.g., an SSD) to manage communications between the firmware associated with the hardware acceleration capabilities (e.g., data processing engines) and block device drivers of the guest OS, which may not include the software programs or data drivers having the same or similar hardware acceleration capabilities. In some embodiments, the memory devices described herein enhance usage of the hardware acceleration capabilities and reduce front-end costs of implementing custom drivers at the guest OS (e.g., by using its standard block device drivers).

Particularly, in some implementations, the data processor of the memory device implements data processing operations for artificial intelligence (AI), and hardware acceleration capabilities of the memory device can increase efficiency and/or effectiveness of these operations by reserving computational resources for the data processors and accommodating these AI-related operations within the CSD. In some embodiments, a unified (e.g., standardized) methodology is provided to utilize hardware acceleration capabilities without requiring an end-to-end software and hardware stack.

In one aspect, a method is implemented at a memory device to process data. The memory device has a memory controller, a data processor, and a nonvolatile memory. The method includes obtaining an OS image and executing an OS on the data processor based on the OS image. The OS includes a block device driver for managing data having a predefined format. The method further includes providing payload data having the predefined format by the block device driver, generating input data having a first format associated with a firmware program based on the payload data, and implementing the firmware program external to the OS to process the input data.

In some embodiments, the method further includes implementing the firmware program to generate output data having the first format, generating target data having the predefined format based on the output data, and providing the target data to the OS via the block device driver.

In some embodiments, the block device driver includes an embedded VirtIO driver, and the first format of the input data is configured to comply with a VirtIO data protocol.

In some embodiments, the memory device is coupled to a host device, and the host device is configured to run a host Linux OS. The OS image is provided by the host device and includes a Linux OS image, and the OS executed on the data processor includes a guest Linux OS.

In another aspect, a method is implemented at a memory device to process data. The memory device has a memory controller, a data processor, and a nonvolatile memory. The method includes obtaining an OS image and executing an OS on the data processor based on the OS image. The OS includes a block device driver for managing data having a predefined format. The method further includes implementing a firmware program external to the OS to generate output data having a first format associated with the firmware program, generating target data having the predefined format based on the output data, and providing the target data to the OS via the block device driver.

In another aspect, some implementations include an electronic device that includes one or more processors including a memory controller and a data processor, a non-volatile memory coupled to the one or more processors, and memory having instructions stored thereon for performing any of the above methods. In some embodiments, the electronic device is a memory system (e.g., SSDs) or a memory device (e.g., an SSD).

In yet another aspect, some implementations include a non-transitory computer readable storage medium storing one or more programs. The one or more programs include instructions, which when executed by a memory device cause the memory device to implement any of the above methods of processing data on the memory device.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device having one or more memory access queues, in accordance with some embodiments.

FIG. 3 is a block diagram of an example computer system that includes a memory system having an internal processing capability, in accordance with some embodiments.

FIG. 4 is a block diagram of an example computer system including a memory system that operates in compliance with a storage access and transport protocol, in accordance with some embodiments.

FIG. 5 is an example electronic system configured to communicate data between a memory device and a host device, in accordance with some embodiments.

FIG. 6 is a system diagram of an example electronic system for processing data at a memory device having hardware acceleration capabilities, in accordance with some embodiments.

FIG. 7 is a flow diagram of an example method of processing data at a memory device having hardware acceleration capabilities, in accordance with some embodiments.

FIG. 8 is a flow diagram of an example process for compressing data in a memory device, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities (e.g., memory device 600).

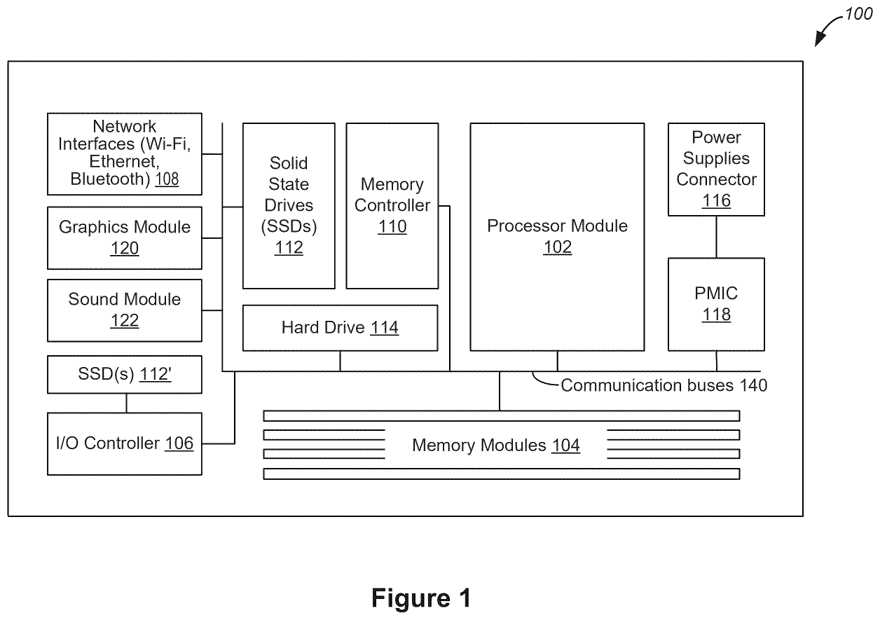

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse, or a trackpad) via a universal serial bus interface. In some embodiments, the network interfaces 108 includes one or more interfaces for Wi-Fi, Ethernet, and Bluetooth networks, each allowing the electronic system to exchange data with an external source (e.g., a server or another electronic system). In some embodiments, the one or more communication buses 140 include circuitry (sometimes called a chipset) that interconnects and controls communications among various system components included in system module 100.

In some embodiments, the memory modules 104 include high-speed random-access memory (RAM), such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash memory devices, or other non-volatile solid state storage devices. In some embodiments, the memory modules 104, or alternatively the non-volatile memory device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively, or additionally, in some embodiments, the system module 100 further includes SSD(s) 112′ coupled to the I/O controller 106 directly. Conversely, the SSD(s) 112 are coupled to the one or more communication buses 140. In an example, the one or more communication buses 140 operates in compliance with PCIe, which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

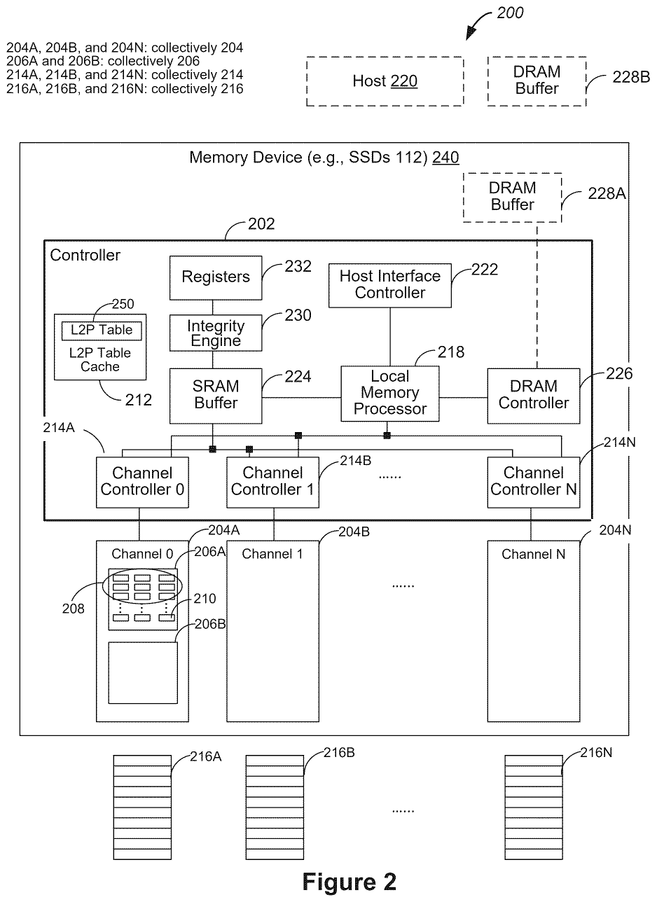

FIG. 2 is a block diagram of a memory system 200 of an example electronic device having one or more memory access queues, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an OS and execute user applications. The memory system 200 includes one or more memory devices 240 (e.g., SSD(s)). Each memory device 240 further includes a memory controller 202 and a plurality of memory channels 204 (e.g., channel 204A, 204B, and 204N). Each memory channel 204 includes a plurality of memory cells. The memory controller 202 is configured to execute firmware level software to bridge the plurality of memory channels 204 to the host device 220. In some embodiments, each memory device 240 is formed on a printed circuit board (PCB).

Each memory channel 204 includes on one or more memory packages 206 (e.g., two memory dies). In an example, each memory package 206 (e.g., memory packages 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks is configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, a host driver of the host device 220 manages the cache, which may thereby be referred to as a host-managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). In some embodiments, each memory cell can store any suitable number of data bits. Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective memory channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing.

In some embodiments, in addition to the channel controllers 214, the memory controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the memory controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the memory controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 250 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the memory controller 202. Alternatively, in some embodiments, the memory system 200 includes a DRAM buffer 228A, and the L2P address indirection table 250 is stored in the DRAM buffer 228A. The local memory processor 218 of the memory controller 202 accesses the DRAM buffer 228A via a DRAM controller 226.

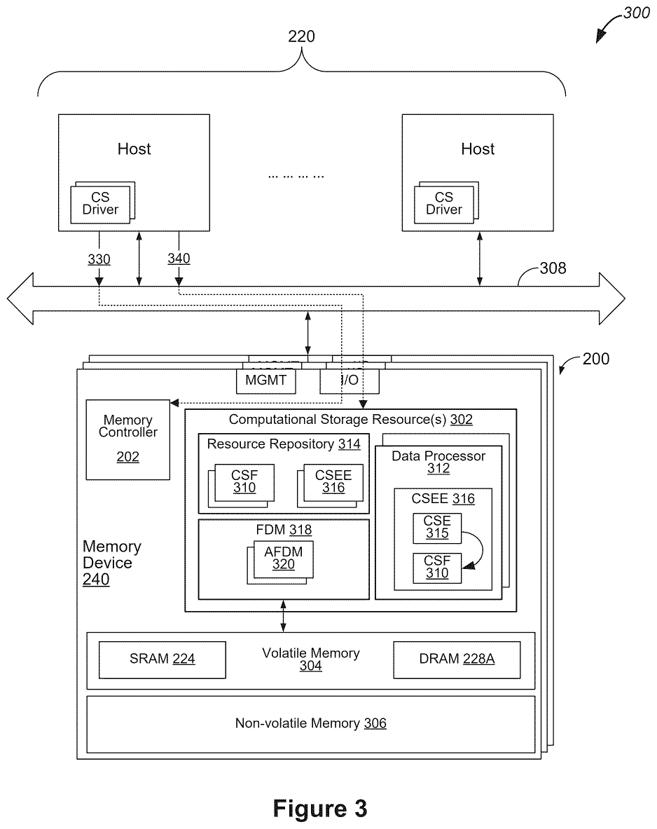

FIG. 3 is a block diagram of an example computer system 300 that includes a memory system 200 having an internal processing capability, in accordance with some embodiments. The memory system 200 is also called a computational storage device (CSD), and includes one or more memory devices 240 (e.g., SSDs). Each memory device 240 further includes a memory controller 202, a volatile memory 304, and a non-volatile memory 306 (e.g., memory channels 204). The host device(s) 220 and the one or more memory devices 240 of the memory system 200 are coupled to each other via a communication fabric 308. The communication fabric 308 includes the one or more communication buses 140 (FIG. 1) that operates in compliance with a data bus standard, e.g., PCIe, Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each memory device 240 further includes one or more of a L2P table cache 212, a SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the communication fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the memory device 240. The resource repository 314 is a centralized location (e.g., memory space) storing distinct types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 22 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

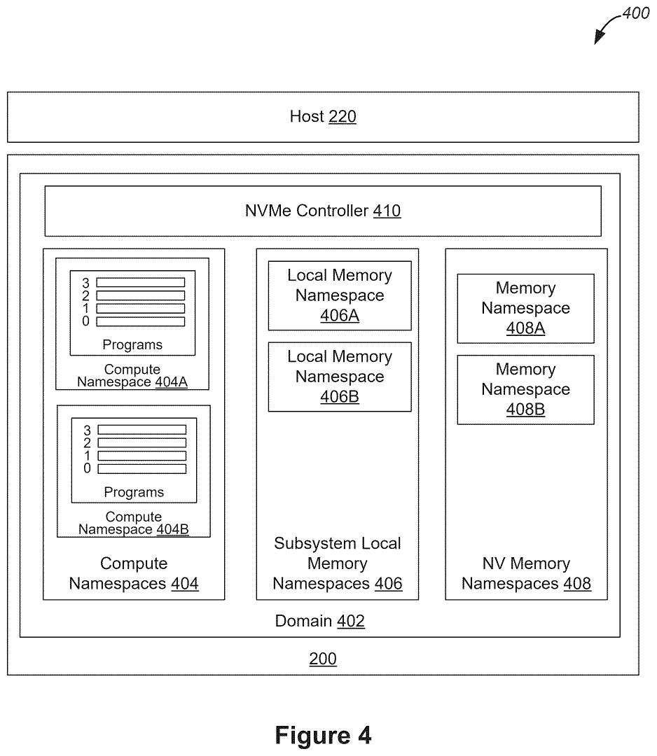

FIG. 4 is a block diagram of an example computer system 400 including a memory system 200 that operates in compliance with a storage access and transport protocol (e.g., NVMe), in accordance with some embodiments. The memory system 200 includes one or more memory devices 240 each of which corresponds to a domain 402 according to the storage access and transport protocol. Each domain 402 corresponding to a respective memory device 240 includes a one or more compute namespaces 404, local memory namespaces 406, memory namespaces 408, and a domain controller 410. Each namespace is a collection of LBAs accessible to, or associated with, a respective one of the plurality of programs.

A memory device 240 includes one or more processors having a computation capability (e.g., a memory controller 202, a data processor 312), a volatile memory 304 (e.g., a table cache 212, a SRAM buffer 224, a DRAM buffer 228A), and a non-volatile memory 306. When the memory device 240 executes a plurality of programs, resources of the memory controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the memory device 240. Resources of the volatile memory 304 are allocated based on a plurality of local memory namespaces 406 (e.g., 406A and 406B) to facilitate execution of the plurality of programs by the memory device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the memory device 240. In some embodiments, input data that are processed, and output data that are generated, by these instructions are temporarily stored based on the local memory namespace 406A. In some embodiments, the input data are extracted based on the non-volatile memory namespace 408A, and the output data are stored based on the non-volatile memory namespace 408A. By these means, namespace allocation and utilization in the domain 402 corresponding to the memory device 240 are managed according to the storage access and transport protocol.

In some embodiments, the storage access and transport protocol includes a NVMe protocol for accessing flash storage (e.g., SSDs) via a PCIe bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each memory device 240 (e.g., SSD) as a standard NVMe storage device using the NVMe protocol. The host device 220 is configured to read and write data and implement data processing operations on the memory device 240 using NVMe commands.

In some embodiments, the host device 220 executes an OS (e.g., a Linux OS) on a host side, and the CSRs 302 (FIG. 3) of the memory device 240 executes the OS on a storage side (e.g., an embedded Linux OS).

In some embodiments, a memory device 240 (also called a storage device) includes a plurality of processing cores, and is transformed to a computational storage device (CSD) by activating a computational storage, including configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., input/output (I/O) access operations) and internal memory management functions. In some embodiments, the memory controller 202 and the data processor 312 of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

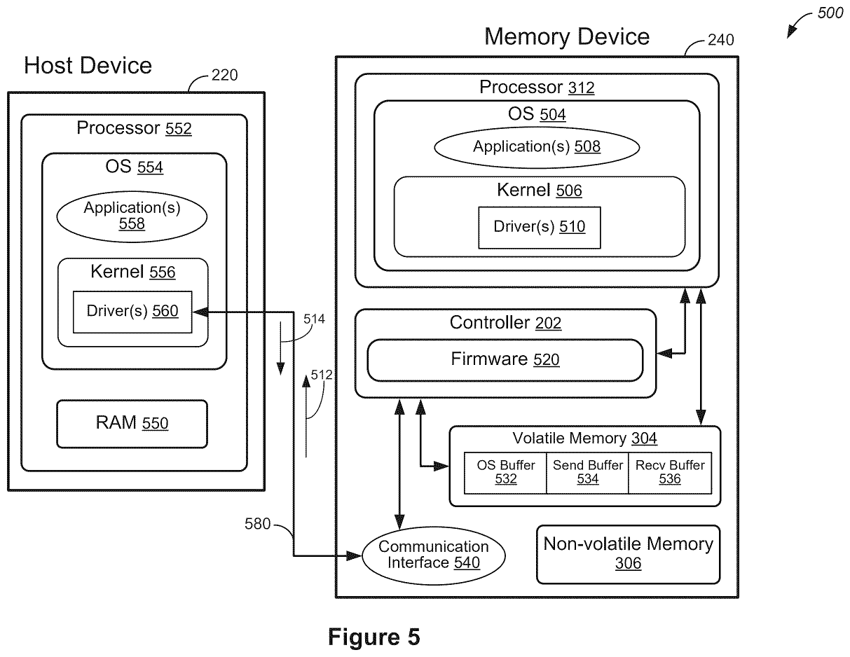

FIG. 5 is a block diagram of an example electronic system 500 configured to communicate data between a memory device 240 and a host device 220, in accordance with some embodiments. The host device 220 and the memory device 240 are coupled to one another, and communicate data via a communication bus 580. In some embodiments, the communication bus 580 includes a PCIe communication bus. In an example, the communication bus 580 is configured to communicate data between the memory device 240 and the host device 220 according to a PCIe interface standard. In some embodiments, the memory device 240 sends an outgoing data packet 512 to the host device 220 via the communication bus 580. In some embodiments, the outgoing data packet 512 is structured in one or more protocol formats, e.g., including a subset of TCP/IP, NVMe, PCIe, Virtual I/O Device (VirtIO), and other types. Further, in some embodiments, the outgoing data packet 512 includes one or more data segments, and each data segment of the outgoing data packet 512 includes a respective protocol-specific header that has a respective data format defined based on a respective protocol format. For example, a data segment includes a header defined according to VirtIO, which is an interface standard for virtualization that facilitates efficient data communication between virtual machines and physical hardware (e.g., virtual device driver(s)).

In some embodiments, the memory device 240 receives an incoming data packet 514 that are sent from the host device 220 via the communication bus 580, and the incoming data packet 514 is structured in one or more protocol formats, e.g., including a subset of TCP/IP, NVMe, PCIe, VirtIO, and other types. In some embodiments, the host device 220 receives the outgoing data packet 512 sent from the memory device 240 via the communication bus 580, and the memory device 240 receives the incoming data packet 514 sent from the host device 220 via the communication bus 580. Bidirectional communication is established within the communication link 580 coupled between the memory device 240 and the host device 220. In some embodiments, the memory device 240 acts as a standard NVMe storage device (e.g., a physical device) to the host device 220. The host device 220 accesses data stored in the memory device 240 and controls the memory device 240 using standard NVMe commands. Alternatively, in some embodiments, the memory device 240 acts as a VirtIO virtual network device (e.g., a virtual device) to the host device 220. The host device 220 accesses data stored in the memory device 240 and controls the memory device 240 using virtual device driver(s) based on VirtIO.

In some embodiments, the host device 220 includes a host processor 552 and a random-access memory (RAM) 550. The host processor 552 is configured to execute a host OS 554 (e.g., Linux) jointly with the memory device 240. The host OS 554 includes one or more of: host application(s) 558 for implementing predefined functions and a host kernel 556 including one or more data drivers 560. For example, the host kernel 556 includes one of a set of data drivers 560, e.g., application driver(s) associated with the host application(s) 558, a PCIe/NVMe driver associated with data communication via the communication bus 580, and a VirtIO network driver for emulating a VirtIO device.

The memory device 240 includes a data processor 312, a memory controller 202, a volatile memory 304 (also called a memory buffer), a non-volatile memory 306, and an input/output data interface 540. The input/output data interface 540 is configured to couple to the communication bus 580 and communicate data via the communication bus 580. The communication bus 580 is configured to communicate data (e.g., data packets 512 and 514) between the input/output data interface 540 and the host device 220, e.g., according to the PCIe interface standard. The data processor 312 is coupled to the input/output data interface 540. In some embodiments, the data processor 312 is configured to execute an embedded OS 504 (e.g., Linux). The embedded OS 504 includes device application(s) 508 and an embedded kernel 506. The embedded kernel 506 includes one or more device drivers 510. For example, the embedded kernel 506 includes one of a set of device drivers, e.g., a block device driver, a VirtIO network driver.

In some embodiments, the memory controller 202 is coupled to the data processor 312, the volatile memory 304, and the input/output data interface 540. The memory controller 202 is distinct from the data processor 312 and configured to execute a firmware 520. In some embodiments, the firmware 520 of the memory controller 202 includes a NVMe firmware for implementing storage functions.

The volatile memory 304 is coupled to the data processor 312 and the memory controller 202. The volatile memory 304 includes a first buffer portion 532 (e.g., an OS buffer 532) allocated to the data processor 312 and a second buffer portion allocated to the memory controller 202. In some embodiments, the second buffer portion includes an outgoing buffer portion 534 (e.g., a send buffer 534) and a receiving buffer portion 536 (e.g., a receive buffer 536). In some embodiments, the send buffer 534 is configured to store data that are extracted from the non-volatile memory 506 and sent over the bus 580, and the receive buffer 536 is configured to store data received from the bus 580 in the non-volatile memory 506. Alternatively, in some embodiments, the send buffer 534 is configured to store data that are extracted from the non-volatile memory 506 and sent over the embedded OS 504, and the receive buffer 536 is configured to store data received from the embedded OS 504 in the non-volatile memory 506. In some embodiments, the volatile memory 304 includes a double data rate dynamic random-access memory (DDR DRAM). In some embodiments, the volatile memory 304 includes the DRAM buffer 228A (FIG. 2), the SRAM buffer 224 (FIG. 2), or both.

The non-volatile memory 306 of the memory device 240 is coupled to the data processor 312 and the memory controller 202. The non-volatile memory 306 includes a plurality of memory blocks (e.g., corresponding to a plurality of memory channels 204 in FIG. 2). A subset of the plurality of memory blocks of the non-volatile memory 306 is reserved for the data processor 312. In some embodiments, the non-volatile memory 306 includes NAND flash memory.

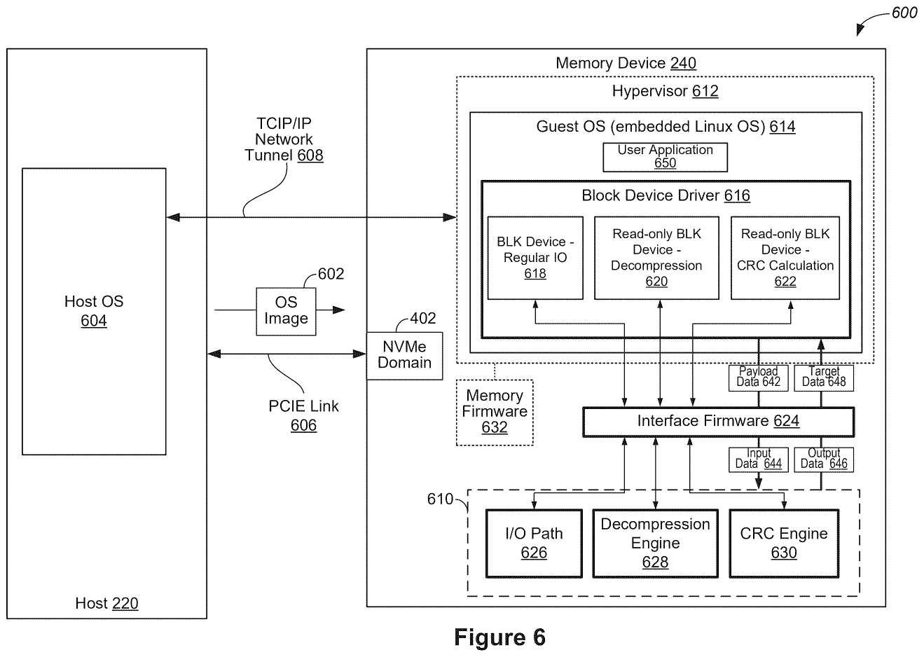

In some embodiments, the memory device 240 is emulated and exposed to the host device 220 as a virtual device through a paravirtualized interface. For example, the parvirtualized interface is formed based on a hypervisor (e.g., hypervisor 612 in FIG. 6), a virtualization firmware, and a virtual machine (e.g., a guest OS) in the memory device 240. More specifically, in some embodiments, the data processor 312 performs as the virtual machine of the host device 220 via its OS 504, and the memory device 240 allocates a subset of processing resources to provide the hypervisor and the virtualization firmware for communicating with and managing the data processor 312. Compared with full virtualization, the OS 504 of paravirtualization is configured to communicate directly with the hypervisor. This paravirtualization configuration allows the OS 504 to make hypercalls to the hypervisor for resource management and I/O operations, thereby reducing virtualization overhead and enhancing total performance.

FIG. 6 is a system diagram of an electronic system 600 for processing data at a memory device 240 having hardware acceleration capabilities, in accordance with some embodiments. The memory device 240 is a computational storage device and is coupled to the host device 220. More specifically, the memory device 240 includes at least a data processor 312, a memory controller 202, and a non-volatile memory 306. The data processor 312 is configured to execute a guest OS 614 (e.g., an embedded Linux OS). In some embodiments, the memory device 240 is herein transformed to a CSD by incorporating at least one computing element. In an example, the memory device 240 includes the data processor 312. The data processor 312 is configured to process internal computational workloads (e.g., the data processing operations) locally on the memory device, while a memory controller 202 of the memory device 240 specializes in performing memory access functions and internal memory management functions.

In some embodiments, the electronic system 600 includes a host device 220. The host device 220 includes at least a host processor configured to execute a host OS 604 (e.g., Linux). The memory device 240 is coupled to, and in electronic communication with, the host device 220 (e.g., via a PCIE link 606). In some embodiments, the memory device 240 may include a hypervisor 612 that is configured to manage operations of respective partitions of the memory device 240, such as the guest OS 614 (which may be an embedded Linux OS). In some embodiments, the hypervisor 612 is implemented by a memory firmware 632 executed on a firmware level in the memory device 240.

In some embodiments, the guest OS 614 includes a plurality of block device driver 616, e.g., a block device driver for managing data having a predefined format. The block device drivers 616 may be native to the guest OS 614. For example, the block device drivers 616 include respective modules for aspects of managing the data having the predefined format, such as block device 618 for standard input and output processing tasks, a block device 620 for managing decompression operations, and another block device 622 for managing cyclic redundancy check (CRC) calculation operations. In an example, the block devices 620 and 622 are read-only. In some embodiments, each block device driver 616 of the block device driver 616 includes a nonvolatile mass storage device storing information related to a respective operation (e.g., decompression operation, a CRC calculation operation, an I/O operation, etc.). In an example, the plurality of block device drivers 616 operates based on an open standard (e.g., VirtIO) that defines a protocol for communication between the block device drivers 616 and devices external to the data processor 312.

In accordance with some embodiments, the memory device 240 is configured to obtain an OS image 602 from the host device 220 (e.g., an image of the guest OS 614), and the memory device 240 is configured to upload, virtualize, start, and/or run the guest OS 614 based on the received OS image 602. The block device drivers 616 may be loaded when the OS image 602 is executed, and does not need to be installed with a separate program distinct from the OS image 602. In some embodiments, the memory device 240 implements the hypervisor 612 with the memory device 240 (e.g., to manage a virtual machine (VM) that is running in conjunction with the guest OS 614). In some embodiments, the hypervisor 612 is configured to manage the OS 614 being executed based on the OS image 602 and the data processor 312 as virtual machines associated with the memory controller 202.

In accordance with some embodiments, the memory device 240 provides customized hardware for accelerating computing tasks performed at the electronic system 600 (e.g., at the guest OS 614, and/or the host OS 604). In some embodiments, the memory device 240 includes memory firmware 632 and/or interface firmware 624, and each firmware 624 or 632 may reflect an instance of the custom hardware for accelerating computing tasks implemented by the guest OS 614 (which is implemented by the data processor 312). The memory firmware 632 and interface firmware 624 may be communicatively coupled with modules of the block device driver 616 of the guest OS 614. For example, the interface firmware 624 may include, and/or be coupled with, one or more firmware programs 610 that provide hardware acceleration capabilities of the electronic system 600. Examples of the firmware programs 610 include, but are not limited to an I/O path module 626, a decompression engine 628, and a CRC engine 630. In some embodiments, the hypervisor 612 manages coupling of the firmware 624 with the block device driver 616 of the guest OS 614 (e.g., the devices 618 to 622). In some embodiments, the interface firmware 624 includes a VirtIO device firmware for interfacing with a VirtIO based block device driver 616 and converting data formats for the block device drivers 616 and the firmware programs 610.

In some embodiments, the interface firmware 624 is configured to couple a plurality of block devices of the guest OS 614 to a plurality of firmware programs 610 formed on a firmware level. For example, the block device 618 is coupled to the I/O path module 626 to receive data from, or provide data to, standard input and output processing tasks. The block device 620 is coupled to the decompression engine 628 to receive data from, or provide data to, decompression operations. The block device 622 is coupled to the CRC engine 630 to receive data from, or provide data to, CRC calculation operations. Stated another way, each device driver 616 is configured to manage respective data having a respective format and provide the respective data to a respective set of one or more firmware programs 610.

Further, in some embodiments, the firmware 624 is configured to use customized NVMe namespaces associated with the firmware programs 610. For example, each firmware program 610 (e.g., the I/O path module 626) is applied to facilitate operations of the guest OS jointly with a respective namespace assigned to the respective firmware program 610. Additionally, in some embodiments, a user can dynamically create namespaces, and during a management operation, can specify the acceleration backend. The firmware 624 is configured to dynamically associate a supplemental namespace with a firmware program 610 (e.g., the I/O path module 626) when the firmware program 610 is applied to facilitate operations of the guest OS 614 (e.g., in addition to an existing namespace that has already been assigned to the firmware program 610 during a memory access operation requested by the host device 220). For clarification, in some embodiments, the program 610 can be applied with a guest OS 614 accessing appropriate block devices, and as well by associated namespaces 404-408 when the host 604 requests corresponding functions.

In some embodiments, the electronic system 600 includes a TCIP/IP network tunnel 608 for facilitating communications between the host OS 604 and the guest OS 614. In some embodiments, the hardware acceleration capabilities of the memory device 240 can be exposed to aspects of the host device 220 (e.g., to accelerate hardware operations initiated by the host OS 604) by applying a similar coupling to that described with respect to the guest OS 614. For example, using a customized NVMe namespace in a NVMe domain 402 (FIG. 4), the hardware acceleration of the memory device 240 can be exposed to the host OS 604, which may be communicated using a means complying with the NVMe standard protocol. Alternatively, in some embodiments, the hardware acceleration can be the TCIP/IP network tunnel 608.

More specifically, in some embodiments, a block device driver 616 of the guest OS 614 is applied to manage data having a predefined format. The block device driver 616 provides payload data 642 having the predefined format by the block device driver 616. Input data 644 is generated based on the payload data 642 and has a first format associated with a firmware program 610. The firmware program 610 is external to the OS 614 and implemented to process the input data 644. In some embodiments, the firmware program is implemented to generate output data 646 having the first format. Target data 648 are generated based on the output data 646 and have the predefined format. The target data 648 are provided the target data to the guest OS 614 via the block device driver 616. In some embodiments, the block device driver 616 includes an embedded VirtIO driver, and the first format of the input data is configured to comply with a VirtIO data protocol.

In some embodiments, the block device driver 616 is loaded jointly with an OS image 602, and does not need to be installed separated. The data processor 312 forgoes installation of a custom data driver for data communication with the memory controller 202 or the host device 220 coupled to the memory device 240. The custom data driver is distinct and separate from the guest OS 614.

In some embodiments, the firmware program 610 includes at least one of: a cyclic redundancy check engine 630, a data compression engine, a data decompression engine 628, an encryption engine, a decryption engine, a visual processing module, a data sorting engine, a pattern identification module, a math operation module, a parity check engine, an error correction engine, and an input/output path module 626. In some embodiments, a cyclic redundancy check is implemented on the input data 644 having the first format. In some embodiments, the input data 644 having the first format is transferred for storage in the non-volatile memory 306. In some embodiments, a parity of the input data 644 having the first format is checked. In some embodiments, the input data 644 having the first format are compressed. In some embodiments, the input data 644 having the first format are decompressed. In some embodiments, the input data 644 having the first format are encrypted. In some embodiments, the input data 644 having the first format are decrypted. In some embodiments, an error of the input data 644 having the first format is corrected. In some embodiments, the input data 644 having the first format are sorted. In some embodiments, a data pattern is identified in the input data 644 having the first format. In some embodiments, a match operation is applied on the input data 644 having the first format. In some embodiments, when the input data 644 include visual data, a visual transformation is implemented on the input data 644.

In some embodiments, the hypervisor 612 is implemented on the memory device 240 to manage the data processor 312 (which executes the guest OS 614) as a virtual machine. The payload data 642 or the input data 644 are temporarily stored in a buffer (e.g., included in the volatile memory 304 in FIG. 3). The buffer is shared by the hypervisor 612 and the OS 614 of the data processor 312. In some embodiments, the payload data 642 are stored in a first buffer (e.g., OS buffer 532 in FIG. 5) associated with the OS 614, and the payload data 642 is copied from the first buffer to a second buffer (e.g., receive buffer 536 in FIG. 5) associated with the firmware program 610. The input data 644 are stored in the second buffer.

In some embodiments, the firmware programs 610 are used to facilitate processing of memory access requests by the memory controller 202 and data processing operations of the data processor 312. In response to a memory access request (e.g., write or read command) received from the host device 220, the memory controller 202 may need to identify, in a logical block addressing (LBA) range, a physical memory address corresponding to a logical address included in the memory access request. When no memory access request is received from the host device 220, the firmware programs 610 may be released to facilitate the data processing operations of the data processor 312. The guest OS 614 executes the unmap (trim) command on the LBA range, and use a subset of volatile memory 304 to support the operations of the firmware programs 610. In some embodiments, when the accelerator resources of the memory device 240 are released, the guest OS 614 is caused to execute an unmap (trim) command on the LBA range associated with the original write or read command that invokes the accelerator resources, which can cause any temporary memory buffers to be freed up for further computational tasks.

In some embodiments the firmware 624 or 632 of the memory device 240 is configured to handle more than one I/O computational command. In some embodiments, the electronic system 600 is configured to prevent a user from specifying an interleaving LBA range in a given plurality of I/O computational commands. In some embodiments, if an interleaving LBA range is specified, the memory device 240 is configured to return an I/O error to a respective application of the guest OS 614. In some embodiments, the hypervisor 612 is configured to provide I/O errors (e.g., via a respective application of the guest OS), such as instances of a wrong buffer and wrong content of data.

In some embodiments, the memory device 240 executes a user application 650 in the OS 614, and receives, from the user application 650, a data write or data read command specifying logical block addressing (LBA). The memory controller 202 may access the non-volatile memory 306 in response to the data write or read command issued from the OS 614 running on the data processor 312. After completion of the data write or read command, the memory device 240 releases a buffer (e.g., included in the volatile memory 304 in FIG. 3) associated with the write or read command based on the logical block addressing (LBA).

In some embodiments, the memory controller 202 receives a data access request from the OS 614, and in response to the data access request, the firmware program 610 is implemented based on at least one non-volatile memory express (NVMe) namespace. Further, in some embodiments, the firmware program 610 includes a plurality of hardware acceleration engines (e.g., modules 626-630) implemented based on a plurality of NVMe namespaces, and each hardware acceleration engine corresponds to a distinct NVMe namespace. Additionally, in some embodiments, the plurality of NVMe namespaces is dynamically created based on load conditions of the plurality of hardware acceleration engines. In some embodiments, the CRC engine 630 has a larger load than the decompression engine 628 and the I/O path module 626, and is allocated with larger NVMe namespaces (e.g., corresponding to large allocations in compute name spaces 404, local memory namespaces 406, and non-volatile memory namespaces 408 in FIG. 4).

In some embodiments, the data access request issued by the OS 614 includes a plurality of data write or read commands. Each hardware acceleration engine is executed in response to a respective data write or read command specifying a respective LBA range. Respective LBA ranges of the plurality of data write or read commands are not interleaving.

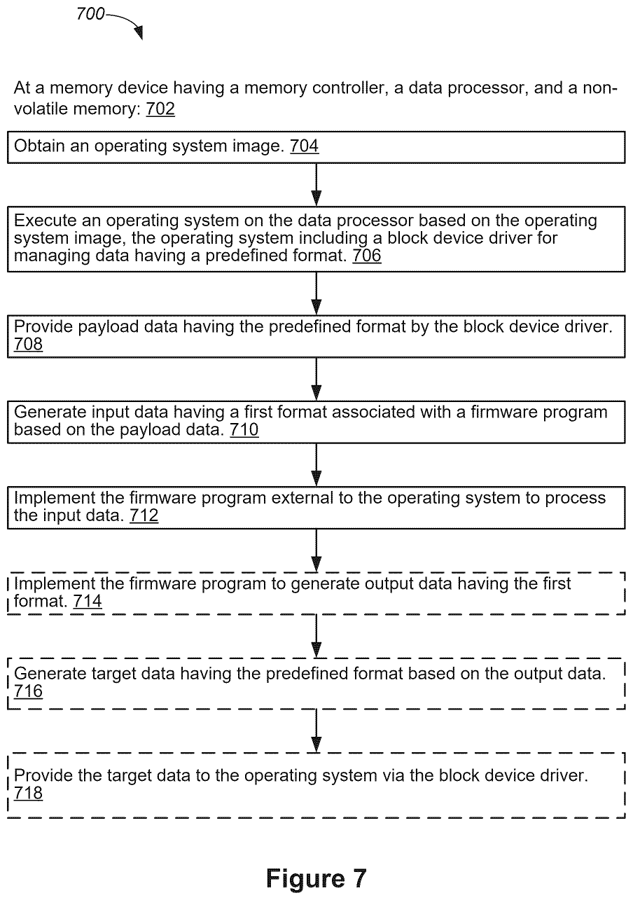

FIG. 7 is a flow diagram of an example method 700 for processing data at a memory device 240 having hardware acceleration capabilities, in accordance with some embodiments. The method 700 can be implemented at a memory device 240 (which may be part of the electronic system 600 in FIG. 6 ) to virtualize, start, and run an uploaded OS 614 and provide customized hardware for acceleration without requiring any corresponding customized drivers to be installed at the uploaded OS 614. In accordance with some embodiments, the method 700 is implemented (operation 702) at a memory device 240 having a memory controller (e.g., the memory controller 202 in FIG. 1), a data processor (e.g., a data processor 312), and a non-volatile memory 306. For ease of description, the method 700 will be described with respect to the memory device 240, though a skilled artisan will appreciate that aspects of the method 700 can be performed at other memory devices having different components than the memory device 240.

The memory device 240 obtains (operation 704) (e.g., from a host device 220 or from memory channels 204), an OS image 602 (e.g., a distribution of a Linux OS). For example, operations performed at the host device 220 (e.g., by the host OS 604) may cause a Linux distribution to be installed within a portion of the memory device 240 (e.g., the guest OS 614). The memory device 240 executes (operation 706) an OS on the data processor based on the OS image 602. The OS 614 includes a block device driver 616 for managing data having a predefined format. For example, the guest OS 614 includes the block device drivers 616, which may be installed by default as part of installing the OS image 602.

The block device driver 616 provides (operation 708) payload data 642 having the predefined format. For example, the block device 618 may cause payload data 642 of a first format to be generated at the guest OS 614, based on a standardized formatting of the block device 618. In accordance with some embodiments, in response to a user-specified LBA, data buffer, and/or a length of a data buffer (e.g., the user performing a “write” command), the hypervisor 612 may receive information about the write command outside of the guest OS 614. In some embodiments, in accordance with a determination that the original buffer of the write command is not a shared buffer, the hypervisor 612 may copy data corresponding to the write command to another buffer in the memory device 240 (e.g., outside of the guest OS 614). In some embodiments, the guest OS 614 obtains (e.g., via an application notification) an indication that write completion has occurred after the hypervisor 612 has managed the backend write command (or confirmed availability via the shared buffer).

The memory device 240 generates (operation 710) input data 644 having a first format associated with a firmware program 610 based on the payload data 642. For example, the guest OS 614 may be performing a compression or decompression task using a buffer of the memory device 240. The buffer may be shared between the guest OS 614 and the hypervisor 612 that was created for the guest OS 614 by the memory device 240.

In some embodiments, the memory device 240 implements (operation 712) the firmware program 610 external to the guest OS 614 to process the payload data 642. For example, after the hypervisor 612 identifies the write command at the guest OS 614, the decompression task may be performed by the decompression engine 628 of the memory device 240. In some embodiments, the decompression engine 628 is applied by the memory controller 202 to decompress data extracted from the non-volatile memory 306 in response to a data access request received from the host device 220.

In accordance with some embodiments of this application, another example method (method 700) for data communication is provided for implementation at a memory device 240 having a memory controller 202 (FIG. 2), a data processor 312 (FIG. 3), and a non-volatile memory 306 (FIG. 3). The memory device 240 obtains an OS image 602 and executes an OS 614 on the data processor 312 based on the OS image, The guest OS 614 includes a block device driver 616 (e.g., VirtIO driver) for managing data having a predefined format. The memory device 240 implements a firmware program 610 (e.g., a firmware program corresponding to one or more of engines 626, 628, or 630 in FIG. 6) external to the guest OS 614 to generate (operation 714) output data 646 having a first format associated with the firmware program 610. The memory device 240 (e.g., the firmware 624 in FIG. 6) generates (operation 716) target data 648 having the predefined format based on the output data 646, and provides (operation 718) the target data 648 to the OS 614 via the block device driver 616 (e.g., by performing a read operation).

Memory is also used to store instructions and data associated with the method 700, and includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 700.

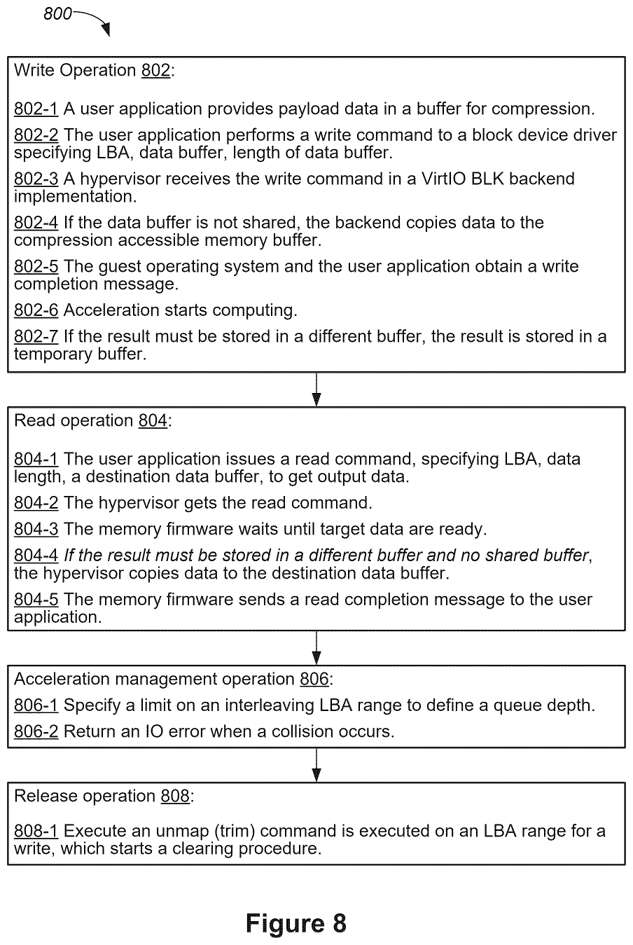

FIG. 8 is a flow diagram of an example process 800 for compressing data in a memory device 240, in accordance with some embodiments. The memory device 240 is transformed to a CSD and includes a data processor 312 for generating payload data 642. The memory device 240 further includes a firmware program 610 used to compress the payload data 642 for the data processor 312. In some embodiments, the firmware program 610 is formed on a firmware level without requiring the guest OS 614 to be customized to include a driver for data compression. Further, in some embodiments, the firmware program 610 is native to the memory device 240 (i.e., already exists in the memory device to support a data compression function of a memory controller 202). In some embodiments, the payload data 642 generated by the data processor 312 based on artificial intelligence.

In some embodiments, the data processor 312 executes a guest OS 614 that further implements a user application 650 for processing data. In some embodiments, the data processor 312 (specifically, the user application 650) applies a neural network model to process data collected from sensors to generate the payload data 642, and the payload data 642 are compressed by the firmware program 610 before the payload data 642 are stored in the non-volatile memory 306 of the memory device 240.

In some embodiments associated with a write operation 802, the data processor 312 provides payload data 642 to be stored in the non-volatile memory 306 or provided to a host device 220. The payload data 642 to be compressed are stored (operation 802-1) in a buffer. The buffer might be shared (like CMB) between the embedded Linux and hypervisor (SSD FW). A write command is generated (operation 802-2) and sent to the block device driver 616 specifying an LBA, a data buffer, and a length of data buffer. The hypervisor 612 receives (operation 802-3) the write command in a VIRTIO BLK backend implementation. If the data buffer is not shared, the backend copies (operation 802-4) data to a compression accessible memory buffer. The guest OS 614 and the user application 650 obtain (operation 802-5) a write completion message. The acceleration starts (operation 802-1) computing. If the result must be stored in a different buffer, the result is stored (operation 802-6) in a temporary buffer.

In some embodiments associated with a read operation 804, the data processor 312 obtains input data 646 extracted from the non-volatile memory 306 or obtained from the host device 220. The user application 650 issues (operation 804-1) a read command for getting output data 646 of a firmware program 610. The read command specifies the LBA, data length, a destination data buffer (which is optional in case when the result must be stored in a different buffer). The hypervisor 612 (e.g., implemented by the memory firmware 632) gets (operation 804-2) the read command. The memory firmware 632 waits (operation 804-3) until the target data 648 are ready. Optionally if the target data 648 must be stored in a different buffer and no shared buffer, the hypervisor copies (operation 804-4) data to the destination buffer. The memory firmware 632 sends (operation 804-5) a read completion message to the user application 650.

In some embodiments associated with an acceleration management operation 806, the memory device 240 (specifically, the interface firmware 624) synchronizes data processing using the firmware programs 610, avoids collision, and handles errors. The memory firmware 632, interface firmware 624, and firmware programs 610 may handle more than one IO computational command. In some embodiments, a limit on an interleaving LBA range is specified (operation 806-1) to define a queue depth of operations implemented by the firmware programs 610. In some embodiments, in accordance with a determination that a collision has occurred (e.g., when the payload data 642 are processed by both a compression operation and an encryption operation), the firmware 632 or 624 returns (operation 806-2) an IO error to the user application 650 of the guest OS 614. In some embodiments, the user application 650 receives an error for a wrong buffer or wrong content of data.

In some embodiments associated with a release operation 808, the memory device 240 releases accelerator resources (e.g., NVMe namespaces 404, 406, and 408 created for firmware programs 610 and corresponding to processing, buffering, and storage resources). The accelerator resources may be freed or closed. For example, an unmap (trim) command is executed (operation 808-1) on an LBA range for a write, which starts a clearing procedure on the memory firmware 632 and on an accelerator side including temporary memory buffer freeing.

Some implementations of this application include an SSD device which provides an infrastructure to execute a computational storage program. Some implementations of this application include an SSD device introduces several accelerators which can be used by the computational storage program. Some implementations of this application include a method which presents several block devices to the computational storage program. A plurality of block devices may correspond, and be mapped, to the SSD's accelerators. The computational storage program may execute a write to a block device to input data to the accelerator. The computational storage program may execute a read from the block device to get an output from the accelerator. The computational storage program may execute a trim on a block device to release the resources of the acceleration executions command. Some implementations of this application include a shared buffer memory between the computational storage program and an accelerator to avoid coping data between them. Some implementations of this application include an orchestration method to enable presenting a specific accelerator to the computational storage program. Some implementations of this application include an orchestration method to disable presenting a specific accelerator to the computational storage program. Some implementations of this application include an orchestration method to configure a specific accelerator capability. More details on hardware acceleration for data processing on memory devices are discussed above with reference to FIGS. 1-8.

In some embodiments, a host device 220 compiles a Linux distribution (e.g., an OS image 602 in FIG. 6) for an advanced reduced instruction set computer (RISC) machines (ARM) architecture including VirtIO drivers (e.g., block device drivers 616. The host device 220 loads the Linux distribution using an NVMe command. The memory device 240 may virtualize execution environment using Hypervisor 612 implemented on a firmware level. The memory device 240 boots the Linux distribution to execute an embedded Linux OS 614 in a hypervisor virtualized environment. The Linux OS 614 discovers one or more virtualized devices automatically (e.g., through an embedded device tree). The Linux OS 614 may access internal storage resources (e.g., volatile memory 304, non-volatile memory 306) through the virtualized devices.

In some embodiments, the memory device 240 loads an unmodified Linux image (e.g., an OS image 602 in FIG. 6) externally. No custom application-specific integrated circuit (ASIC) patches are required to make the Linux image work and detect virtual devices. In some embodiments, the memory device 240 is required to support a VirtIO protocol, which is already part of Linux kernel. A host device 220 may supply, deploy, and load Linux images to the memory device 240 (e.g., SSD) without installing a customized device driver in the guest OS 614. In some embodiments, the memory device 204 is configured to provide a secure hypervisor 612 and implementation of VirtIO devices on a firmware level. The host device 220 may manage maintenance and security of the Linux distribution with flexibility, allowing the memory device 240 to simplify its operations, enhancing its release rate, and avoid being exposure to security vulnerabilities present in Linux distribution. By these means, a unified way of presenting CSDs is made available on a firmware level and a hardware level and without involving a custom software or driver in the guest OS 614.

Some implementations of this application include a memory device that includes an infrastructure for executing a computational storage program, provides a hypervisor and a VirtIO backend implementation on a firmware level to execute an unmodified Linux image, introduces accelerators which can be used by a computational storage program through an Linux VirtIO frontend interface, and load Linux automatically discover virtual devices or resources. The hypervisor provides acceleration needed to access resources of the memory device 240 securely and efficiently.

Numerous examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.
Clause 1. A method for processing data on memory devices, comprising: at a memory device having a memory controller, a data processor, and a non-volatile memory: obtaining an OS image; executing an OS on the data processor based on the OS image, the OS including a block device driver for managing data having a predefined format; providing payload data having the predefined format by the block device driver; generating input data having a first format associated with a firmware program based on the payload data; and implementing the firmware program external to the OS to process the input data.
Clause 2. The method of clause 1, further comprising: implementing the firmware program to generate output data having the first format; generating target data having the predefined format based on the output data; and providing the target data to the OS via the block device driver.
Clause 3. The method of clause 1 or 2, wherein the block device driver includes an embedded VirtIO driver, and the first format of the input data is configured to comply with a VirtIO data protocol.
Clause 4. The method of any of clauses 1-3, wherein the memory device is coupled to a host device, and the host device is configured to run a host Linux OS, and wherein the OS image is provided by the host device and includes a Linux OS image, and the OS executed on the data processor includes a guest Linux OS.
Clause 5. The method of any of clauses 1-4, further comprising forgoing installation of a custom data driver for data communication with the memory controller or a host device coupled to the memory device, the custom data driver being distinct and separate from the OS.
Clause 6. The method of any of clauses 1-5, wherein the firmware program includes at least one of: a cyclic redundancy check engine, a data compression engine, a data decompression engine, an encryption engine, a decryption engine, a visual processing module, a data sorting engine, a pattern identification module, a math operation module, a parity check engine, an error correction engine, and a NAND input/output path.
Clause 7. The method of any of clauses 1-6, wherein implementing the firmware program to process the input data further comprises at least one of: implementing a cyclic redundancy check on the input data having the first format; transferring the input data having the first format for storage in the non-volatile memory; checking a parity of the input data having the first format; compressing the input data having the first format; decompressing the input data having the first format; encrypting the input data having the first format; decrypting the input data having the first format; correcting an error of the input data having the first format; sorting the input data having the first format; finding a data pattern in the input data having the first format; applying a match operation on the input data having the first format; and when the input data include visual data, implementing a visual transformation on the input data.
Clause 8. The method of any of clauses 1-7, wherein the memory device is coupled to a host device, the method further comprising: running a host OS on the host device; and implementing a hypervisor on the memory device to manage the OS being executed based on the OS image and the data processor as virtual machines associated with the memory controller.
Clause 9. The method of any of clauses 1-8, wherein the OS includes a plurality of first device drivers including the block device driver, and each first device driver is configured to manage respective data having a respective format and provide the respective data to a respective set of one or more firmware programs.
Clause 10. The method of any of clauses 1-9, further comprising: implementing a hypervisor on the memory device to manage the data processor as a virtual machine; and temporarily storing the payload data or the input data in a buffer, wherein the buffer is shared by the hypervisor and the OS of the data processor.
Clause 11. The method of any of clauses 1-10, further comprising: temporarily storing the payload data in a first buffer associated with the OS; copying the payload data from the first buffer to a second buffer associated with the firmware program; and storing the input data in the second buffer.
Clause 12. The method of any of clauses 1-11, further comprising: executing a user application in the OS; receiving from the user application a data write or read command specifying logical block addressing (LBA); and after completion of the data write or read command, releasing a buffer associated with the write or read command based on the logical block addressing (LBA).
Clause 13. The method of any of clauses 1-12, further comprising: receiving a data access request from the OS; and in response to the data access request, executing the firmware program based on at least one non-volatile memory express (NVMe) namespace.
Clause 14. The method of clause 13, wherein the firmware program includes a plurality of hardware acceleration engines, executing the firmware program based on at least one NVMe namespace further comprising: executing the plurality of hardware acceleration engines based on a plurality of NVMe namespaces, each hardware acceleration engine corresponding to a distinct NVMe namespace.
Clause 15. The method of clause 14, further comprising dynamically creating the plurality of NVMe namespaces based on load conditions of the plurality of hardware acceleration engines.
Clause 16. The method of any of clauses 13-15, wherein the data access request includes a plurality of data write or read commands, and each hardware acceleration engine is executed in response to a respective data write or read command specifying a respective LBA. A range, and wherein respective LBA. A ranges of the plurality of data write or read commands are not interleaving.
Clause 17. A method for processing data on memory devices, comprising: at a memory device having a memory controller, a data processor, and a non-volatile memory: obtaining an OS image; executing an OS on the data processor based on the OS image, the OS including a block device driver for managing data having a predefined format; providing payload data having the predefined format by the block device driver, generating input data having a first format associated with a firmware program based on the payload data, and implementing the firmware program external to the OS to process the input data.
Clause 18. A non-transitory computer-readable storage medium comprising instructions which, when executed by a memory device having one or more processors, cause the one or more processors to perform a method in any of clauses 1-17.
Clause 19. A memory device, comprising: one or more processors including a memory controller and a data processor; a non-volatile memory; and memory, comprising instructions which, when executed by one or more processors, cause the one or more processors to perform a method in any of clauses 1-17.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software, or any combination thereof.

What is claimed is:

1. A method for processing data on memory devices, comprising:
at a memory device having a memory controller, a data processor, and a non-volatile memory:
obtaining an operating system (OS) image;
executing an OS on the data processor based on the OS image, the OS including a block device driver for managing data having a predefined format;
providing payload data having the predefined format by the block device driver;
generating input data having a first format associated with a firmware program based on the payload data; and
implementing the firmware program external to the OS to process the input data.

2. The method of claim 1, further comprising:
implementing the firmware program to generate output data having the first format;
generating target data having the predefined format based on the output data; and
providing the target data to the OS via the block device driver.

3. The method of claim 1, wherein the block device driver includes an embedded VirtIO driver, and the first format of the input data is configured to comply with a VirtIO data protocol.

4. The method of claim 1, wherein the memory device is coupled to a host device, and the host device is configured to run a host Linux OS, and wherein the OS image is provided by the host device and includes a Linux OS image, and the OS executed on the data processor includes a guest Linux OS.

5. The method of claim 1, further comprising forgoing installation of a custom data driver for data communication with the memory controller or a host device coupled to the memory device, the custom data driver being distinct and separate from the OS.

6. The method of claim 1, wherein the firmware program includes at least one of: a cyclic redundancy check engine, a data compression engine, a data decompression engine, an encryption engine, a decryption engine, a visual processing module, a data sorting engine, a pattern identification module, a math operation module, a parity check engine, an error correction engine, and a NAND input/output path.

7. The method of claim 1, wherein implementing the firmware program to process the input data further comprises at least one of:
implementing a cyclic redundancy check on the input data having the first format;
transferring the input data having the first format for storage in the non-volatile memory;
checking a parity of the input data having the first format;
compressing the input data having the first format;
decompressing the input data having the first format;
encrypting the input data having the first format;
decrypting the input data having the first format;
correcting an error of the input data having the first format;
sorting the input data having the first format;
finding a data pattern in the input data having the first format;
applying a match operation on the input data having the first format; and
when the input data include visual data, implementing a visual transformation on the input data.

8. The method of claim 1, wherein the memory device is coupled to a host device, the method further comprising:
running a host OS on the host device; and
implementing a hypervisor on the memory device to manage the OS being executed based on the OS image and the data processor as virtual machines associated with the memory controller.

9. The method of claim 1, wherein the OS includes a plurality of first device drivers including the block device driver, and each first device driver is configured to manage respective data having a respective format and provide the respective data to a respective set of one or more firmware programs.

10. The method of claim 1, further comprising:
implementing a hypervisor on the memory device to manage the data processor as a virtual machine; and
temporarily storing the payload data or the input data in a buffer, wherein the buffer is shared by the hypervisor and the OS of the data processor.

11. The method of claim 1, further comprising:
temporarily storing the payload data in a first buffer associated with the OS;
copying the payload data from the first buffer to a second buffer associated with the firmware program; and
storing the input data in the second buffer.

12. The method of claim 1, further comprising:
executing a user application in the OS;
receiving from the user application a data write or read command specifying logical block addressing (LBA); and
after completion of the data write or read command, releasing a buffer associated with the write or read command based on the logical block addressing (LBA).

13. A memory device, comprising:
one or more processors including a memory controller and a data processor;
a non-volatile memory; and
memory, comprising instructions which, when executed by one or more processors, cause the one or more processors to perform operations further comprising:
obtaining an OS image;
executing an OS on the data processor based on the OS image, the OS including a block device driver for managing data having a predefined format;
providing payload data having the predefined format by the block device driver;
generating input data having a first format associated with a firmware program based on the payload data; and
implementing the firmware program external to the OS to process the input data.

14. The memory device of claim 13, further comprising instructions for:
receiving a data access request from the OS; and
in response to the data access request, executing the firmware program based on at least one non-volatile memory express (NVMe) namespace.

15. The memory device of claim 14, wherein the firmware program includes a plurality of hardware acceleration engines, executing the firmware program based on at least one NVMe namespace further comprising:
executing the plurality of hardware acceleration engines based on a plurality of NVMe namespaces, each hardware acceleration engine corresponding to a distinct NVMe namespace.

16. The memory device of claim 15, further comprising instructions for dynamically creating the plurality of NVMe namespaces based on load conditions of the plurality of hardware acceleration engines.

17. The memory device of claim 14, wherein the data access request includes a plurality of data write or read commands, and each hardware acceleration engine is executed in response to a respective data write or read command specifying a respective LBA range, and wherein respective LBA ranges of the plurality of data write or read commands are not interleaving.

18. A non-transitory computer-readable storage medium storing instructions which, when executed by a memory device having one or more processors, cause the one or more processors to perform operations comprising:
obtaining an OS image, wherein the one or more processors include a memory controller and a data processor;
executing an OS on the data processor based on the OS image, the OS including a block device driver for managing data having a predefined format;
providing payload data having the predefined format by the block device driver;
generating input data having a first format associated with a firmware program based on the payload data; and
implementing the firmware program external to the OS to process the input data.

19. The non-transitory computer-readable storage medium of claim 18, further comprising instructions for:
implementing the firmware program to generate output data having the first format;
generating target data having the predefined format based on the output data; and
providing the target data to the OS via the block device driver.

20. The non-transitory computer-readable storage medium of claim 18, wherein the block device driver includes an embedded VirtIO driver, and the first format of the input data is configured to comply with a VirtIO data protocol.
